(19) United States
(12) Patent Application Publication
(10) Pub. No.: US 2012/0166602 A1
(43) Pub. Date: Jun. 28, 2012

(54) METHOD AND APPARATUS FOR SETTING UP VEHICLE NETWORK BASED ON AUTOSAR

(75) Inventor: Joo-Chul LEE, Daejeon (KR)

(73) Assignee: ELECTRONICS AND TELECOMMUNICATIONS RESEARCH INSTITUTE, Daejeon-city (KR)

(21) Appl. No.: 13/334,049

(22) Filed: Dec. 21, 2011

(30) Foreign Application Priority Data
Dec. 22, 2010 (KR) 10-2010-0132863
May 30, 2011 (KR) 10-2011-0051568

(51) Int. Cl. G06F 15/177

(52) U.S. Cl. 709/222

(57) ABSTRACT

The present invention relates to a method and apparatus for setting up a vehicle network based on AUTomotive Open System ARchitecture (AUTOSAR). The apparatus for setting up a vehicle network based on AUTOSAR includes a screen unit for externally receiving structure setup input values. A structure setup unit is configured such that when a user selects an Electronic Control Unit (ECU) and a communication cluster on the screen unit, the structure setup unit displays a communication channel between the ECU and the communication cluster, and sets up a network structure based on the communication channel. A data setup unit sets up data that is transmitted through the communication channel using a wizard which is software for executing software or hardware operations using an interrogatory method.

### CROSS REFERENCE TO RELATED APPLICATIONS

This application claims the benefit of Korean Patent Application Nos. 10-2010-0132863 filed on Dec. 22, 2010 and 10-2011-0051568 filed on May 30, 2011, which are hereby incorporated by reference in their entirety into this application.

### BACKGROUND OF THE INVENTION

1. Technical Field

The present invention relates generally to a method and apparatus for setting up a vehicle network based on the AUTomotive Open System ARchitecture (AUTOSAR). More particularly, the present invention relates to a method and apparatus for setting up a vehicle network based on AUTOSAR, which can more easily set up a vehicle network on the basis of AUTOSAR.

2. Description of the Related Art

An automotive electronics software platform standard (AUTomotive Open System ARchitecture, hereinafter referred to as “AUTOSAR”) is a standard for automotive electronics software architecture which was established by a partnership between vehicle manufacturers and manufacturers for related parts and electronics application development tools.

Such AUTOSAR provides an architecture and development methodology for automotive electronics software and Application Programming Interfaces (APIs) for electronics applications.

Automotive electronics software architecture provided by AUTOSAR includes the structures of applications, network structures/communication data between Electronic Control Units (ECUs) on which applications are to be mounted, the structure of lower platform modules that support application software to be loaded onto respective ECUs, and methods of establishing the platform modules.

Such architecture has been provided as a model defined in AUTOSAR, but it is problematic in that guidance related to methods of desirably configuring an actual target model is not yet present. Further, a specific model may be greatly complicated depending on the circumstances. When development tools for AUTOSAR are developed, various schemes which access the setup of such a model may greatly influence the convenience of the user.

### SUMMARY OF THE INVENTION

Accordingly, the present invention has been made keeping in mind the above problems occurring in the prior art, and an object of the present invention is to provide a method and apparatus for setting up a vehicle network based on AUTOSAR, which can more easily set up a vehicle network model using an AUTOSAR-based development tool.

In accordance with an aspect of the present invention to accomplish the above object, there is provided an apparatus for setting up a vehicle network based on AUTOSAR, including a screen unit for externally receiving structure setup input values; a structure setup unit for, when a user selects an Electronic Control Unit (ECU) and a communication cluster on the screen unit, displaying a communication channel between the ECU and the communication cluster, and setting up a network structure based on the communication channel; and a data setup unit for setting up data that is transmitted through the communication channel using a wizard which is software for executing software or hardware operations using an interrogatory method.

Preferably, the structure setup unit may include an ECU instance generation unit for generating ECU instances, each operating in conjunction with a communication controller block and a communication connector block for each ECU, on the screen unit; a cluster instance generation unit for generating communication clusters corresponding to types of communication buses on the screen unit; a connection line generation unit for generating connection lines for connecting the ECU instances to the communication clusters; and a property setup unit for setting up properties of the generated instances using a specific properties viewer.

Preferably, the cluster instance generation unit may generate a FlexRay cluster when the communication bus is a FlexRay bus, and generates a Controller Area Network (CAN) cluster when the communication bus is a CAN bus.

Preferably, the cluster instance generation unit may generate a relevant physical channel whenever each communication cluster is generated.

Preferably, the connection line generation unit may generate a communication controller block and a communication connector block between each ECU instance and each communication cluster and generate reference blocks corresponding to the communication controller block.

Preferably, the structure setup unit may set up the network structure using a graphical user interface.

Preferably, the wizard may include a system signal wizard, an Interaction layer Protocol data unit (IPdu) wizard, and a frame wizard.

Preferably, the data setup unit may include a signal generation unit for generating system signals and Interaction (I) signals using the system signal wizard; an IPdu generation unit for generating IPdus using the IPdu wizard; an ECU selection unit for selecting a source ECU instance and a destination ECU instance from among the ECU instances using the frame wizard; and an IPdu selection unit for selecting an IPdu corresponding to a frame for a type of a communication bus between the source ECU instance and the destination ECU instance.

Preferably, the IPdu may further include a Pdu-to-frame mapping instance.

Preferably, the IPdu selection unit may generate a frame triggering instance, which includes information about frames to be transmitted through a physical channel, using a communication connector block generated by the structure setup unit.

In accordance with another aspect of the present invention to accomplish the above object, there is provided a method of setting up a vehicle network based on AUTOSAR, including externally receiving structure setup input values; when a user selects an Electronic Control Unit (ECU) and a communication cluster, displaying a communication channel between the ECU and the communication cluster, and setting up a network structure based on the communication channel; and setting up data that is transmitted through the communication channel using a wizard which is software for executing software or hardware operations using an interrogatory method.

Preferably, the setting up the network structure may include generating ECU instances, each operating in conjunction with a communication controller block and a communication connector block for each ECU; generating communication clusters corresponding to types of communication buses; and generating connection lines for connecting the ECU instances to the communication clusters.

Preferably, the generating the communication clusters may include generating a FlexRay cluster when the communication bus is a FlexRay bus; and generating a Controller Area Network (CAN) cluster when the communication bus is a CAN bus.

Preferably, the generating the communication clusters may be configured to generate a relevant physical channel whenever each communication cluster is generated.

Preferably, the generating the connection lines may include generating a communication controller block and a communication connector block between each ECU instance and each communication cluster; and generating reference blocks corresponding to the communication controller block.

Preferably, the setting up the network structure may be configured to set up the network structure using a graphical user interface.

Preferably, the wizard may include a system signal wizard, an Interaction layer Protocol data unit (IPdu) wizard, and a frame wizard.

Preferably, the setting up the data using the wizard may include generating system signals and Interaction (I) signals using the system signal wizard; generating IPdus using the IPdu wizard; selecting a source ECU instance and a destination ECU instance from among the ECU instances using the frame wizard; and selecting an IPdu corresponding to a frame for a type of a communication bus between the source ECU instance and the destination ECU instance.

According to an embodiment of the present invention, the method and apparatus for setting up a vehicle network based on AUTOSAR allow an electronics application developer to more easily set up a vehicle network model even if the configuration of a complicated network architecture model based on AUTOSAR is not known.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the construction of an apparatus for setting up a vehicle network based on AUTOSAR according to an embodiment of the present invention;

FIGS. 2 and 3 are diagrams showing a network model based on AUTOSAR according to an embodiment of the present invention;

FIG. 4 is a block diagram showing the construction of a structure setup unit according to an embodiment of the present invention;

FIG. 5 is a diagram showing a structure setup screen unit according to an embodiment of the present invention;

FIG. 6 is a diagram showing a properties viewer according to an embodiment of the present invention;

FIGS. 7 to 10 are diagrams showing a communication data model based on AUTOSAR according to an embodiment of the present invention;

FIG. 11 is a diagram showing the construction of the data setup unit according to an embodiment of the present invention;

FIG. 12 is a diagram showing a method of selecting an ECU instance according to an embodiment of the present invention; and

FIGS. 13 and 14 are flowcharts showing a method of setting up a vehicle network based on AUTOSAR according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, a method and apparatus for setting up a vehicle network based on AUTOSAR according to an embodiment of the present invention will be described in detail with reference to the attached drawings.

The method and apparatus for setting up a vehicle network based on AUTOSAR according to an embodiment of the present invention are based on a software platform standard for automotive electronics (automotive open system architecture, hereinafter referred to as “AUTOSAR”), but the present invention is not limited thereto.

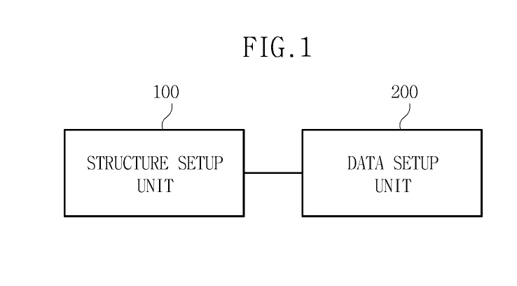

FIG. 1 is a block diagram schematically showing the construction of an apparatus for setting up a vehicle network based on AUTOSAR according to an embodiment of the present invention.

Referring to FIG. 1, the AUTOSAR-based vehicle network setup apparatus includes a structure setup unit 100 and a data setup unit 200.

The structure setup unit 100 receives structure setup input values from a user, generates electronic control units (hereinafter referred to as “ECUs”) corresponding to the components of vehicle network communication, and allocates communication channels between the ECUs. That is, the structure setup unit 100 sets up a network structure model based on the allocated communication channels between the ECUs.

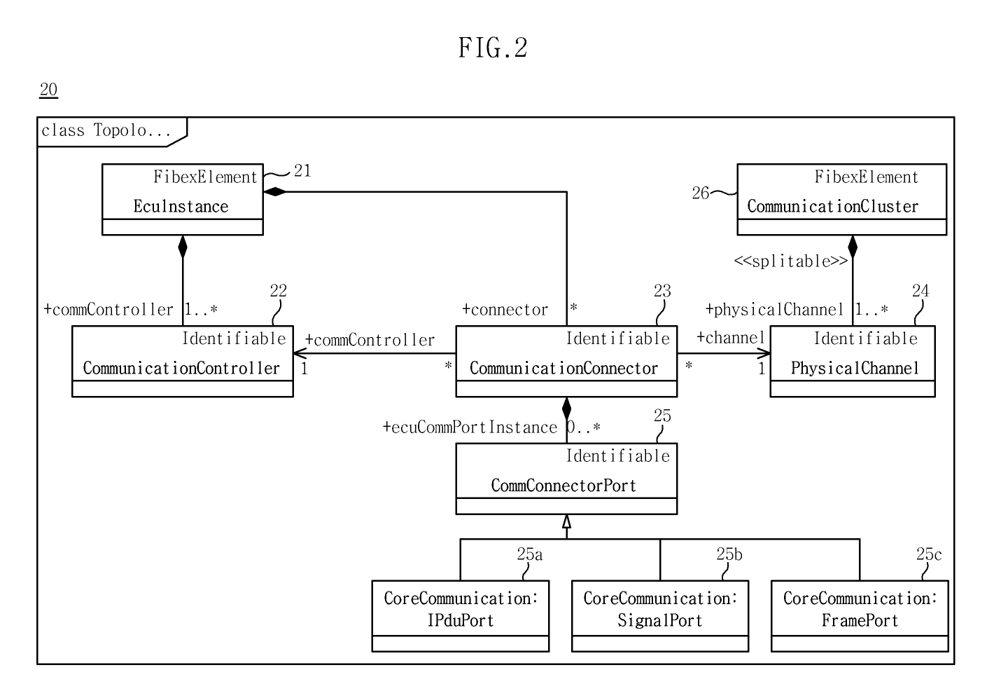

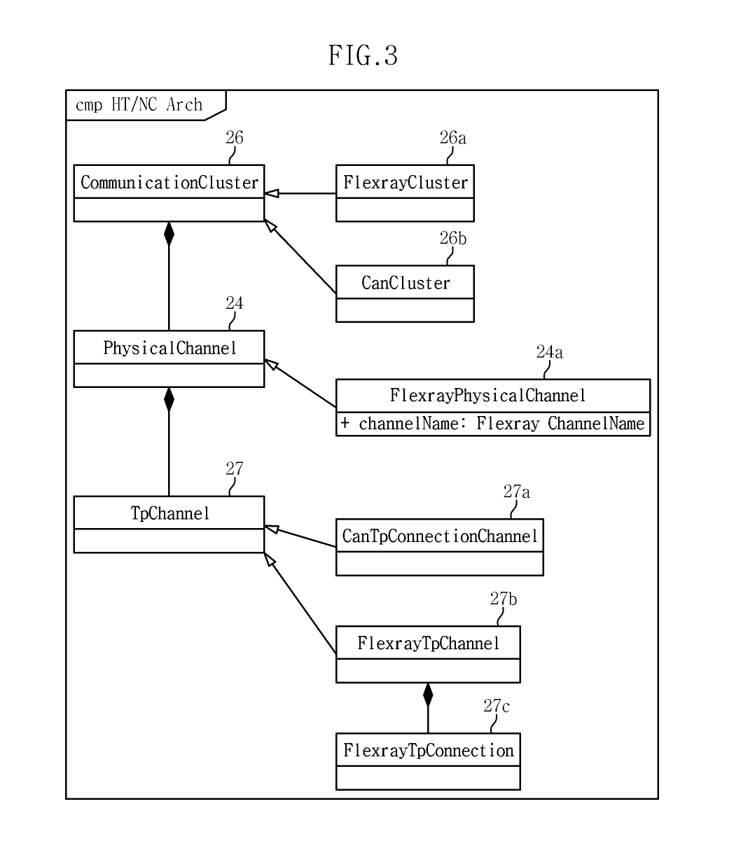

A network model 20 based on AUTOSAR according to an embodiment of the present invention may have the forms shown in FIGS. 2 and 3, but the form of the network model 20 is not limited thereto.

Referring to FIGS. 2 and 3, the structure of the network model 20 includes ECU instances (EcuInstance) 21, communication controller blocks (CommunicationController) 22, communication connector blocks (CommunicationConnector) 23, physical channels (PhysicalChannel) 24, connector port blocks (CommConnectorPort) 25, communication cluster blocks (CommunicationCluster) 26, and Transport layer (Tp) channel blocks (TpChannel) 27.

The ECU instances 21 correspond to instances included in the ECUs with one ECU instance included in each ECU, and work in conjunction with the plurality of communication controller blocks 22 and communication connector blocks 23.

The communication controller blocks 22 are controller blocks corresponding to the interfaces of a vehicle network, for example, FlexRay or Controller Area Network (CAN).

The communication connector blocks 23 are generated when the ECU intends to perform communication using a specific physical channel 24. That is, such a communication connector block 23 corresponds to a connection node between the ECU and the specific physical channel 24. Here, the physical channel 24 includes a FlexRay physical channel 24a. Further, each communication connector block 23 has a corresponding connector port block 25.

Each connector port block 25 includes the directionality of reception (in) and transmission (out) with respect to the physical channel 24.

Each communication cluster block 26 includes a FlexRay cluster (FlexrayCluster) 26a and a CAN cluster (CanCluster) 26b.

Each TP channel block 27 includes a CanTp connection channel (CanTpConnectionChannel) 27a and a FlexRayTp channel (FlexrayTpChannel) 27b. Here, the FlexRayTp channel 27b includes a FlexRayTp connection block (FlexrayTpConnection) 27c.

The above-described network model 20 based on AUTOSAR shown in FIGS. 2 and 3 is disclosed in detail in the Specification of the System Template V3.1.0 of AUTOSAR, and thus a detailed description thereof is omitted here.

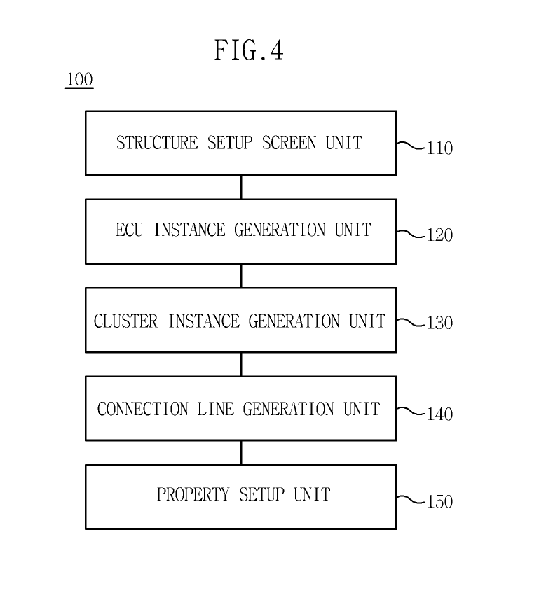

Next, the structure setup unit 100 for setting up the structure of the network model having the forms of FIGS. 2 and 3 will be described in detail with reference to FIG. 4.

FIG. 4 is a block diagram showing the construction of the structure setup unit according to an embodiment of the present invention.

Referring to FIG. 4, the structure setup unit 100 includes a structure setup screen unit 110, an ECU instance generation unit 120, a cluster instance (or object) generation unit 130, a connection line generation unit 140, and a property setup unit 150. In this case, the structure setup unit 100 is shown to include the structure setup screen unit 110, but it is not limited thereto.

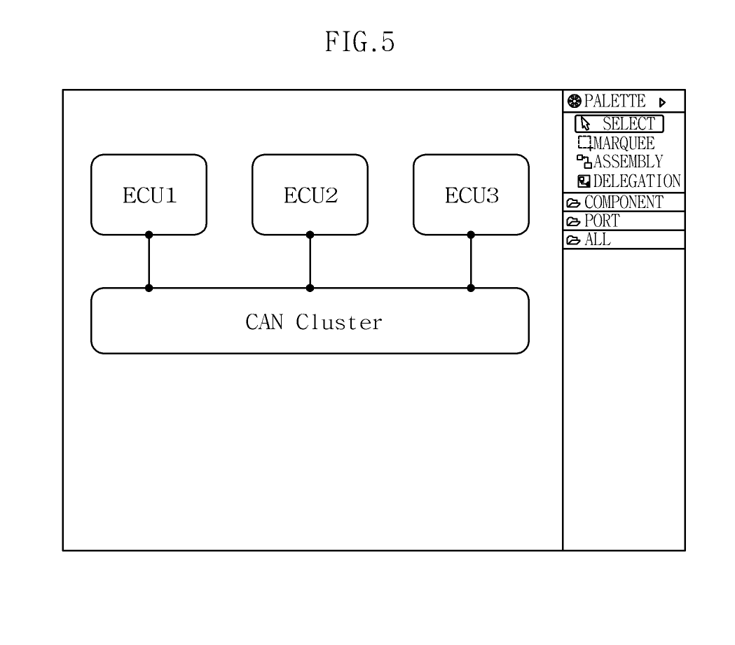

The structure setup screen unit 110 corresponds to a screen including a plurality of input blocks capable of receiving structure setup input values from the user. The structure setup screen unit 110 according to an embodiment of the present invention is exemplified as shown in FIG. 5 in which a Graphical User Interface (GUI) is used, but it is not limited to FIG. 5.

The ECU instance generation unit 120 generates an ECU instance 21 on the structure setup screen unit 110.

The cluster instance generation unit 130 generates a communication cluster block 26 on the structure setup screen unit 110. In this case, the cluster instance generation unit 130 generates a FlexRay cluster 26a or a CAN cluster 26b according to the type of communication bus, for example, a FlexRay bus or a CAN bus.

Further, the cluster instance generation unit 130 generates a single physical channel 24 whenever the communication cluster block 26 is generated.

The connection line generation unit 140 generates connection lines between the generated ECU instances 21 and the generated communication cluster blocks 26. In this case, the connection line generation unit 140 generates communication controller blocks 22 and communication connector blocks 23, and also generates reference blocks corresponding to the communication controller blocks 22 and the physical channels 24.

Further, the connection line generation unit 140 generates two ports, that is, reception (in) and transmission (out) ports.

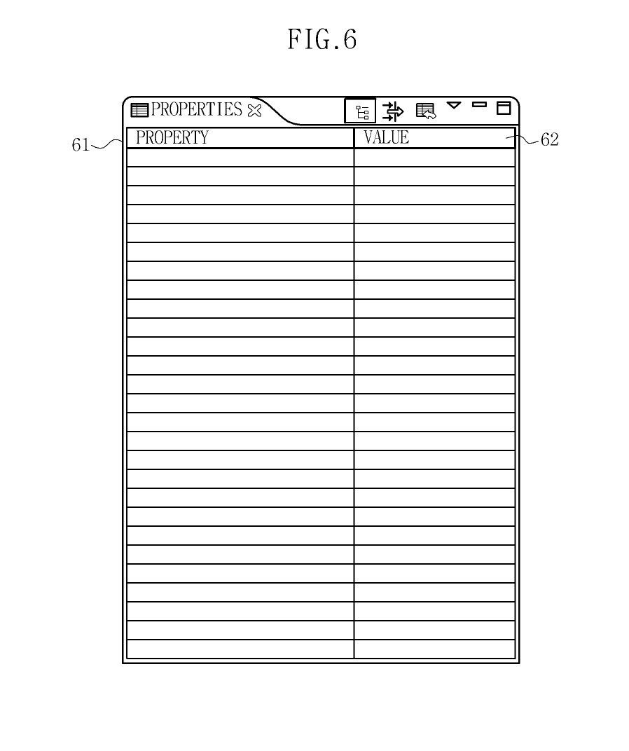

The property setup unit 150 sets up detailed properties of the instances, generated by the respective generation units 120 to 140, using a separate properties viewer. Here, the properties viewer is provided to the user in the form of FIG. 6. Referring to FIG. 6, the properties viewer includes properties 61 and values 62 corresponding to the respective properties.

Referring to FIG. 2, the data setup unit 200 sets up data that is transmitted through the communication channel between the ECUs using a specific wizard. Here, the wizard corresponds to software for easily and conveniently executing complicated software or hardware operations using an interrogatory method, and includes a system signal wizard, an Interaction layer Protocol data unit (IPdu) wizard, a frame wizard, etc.

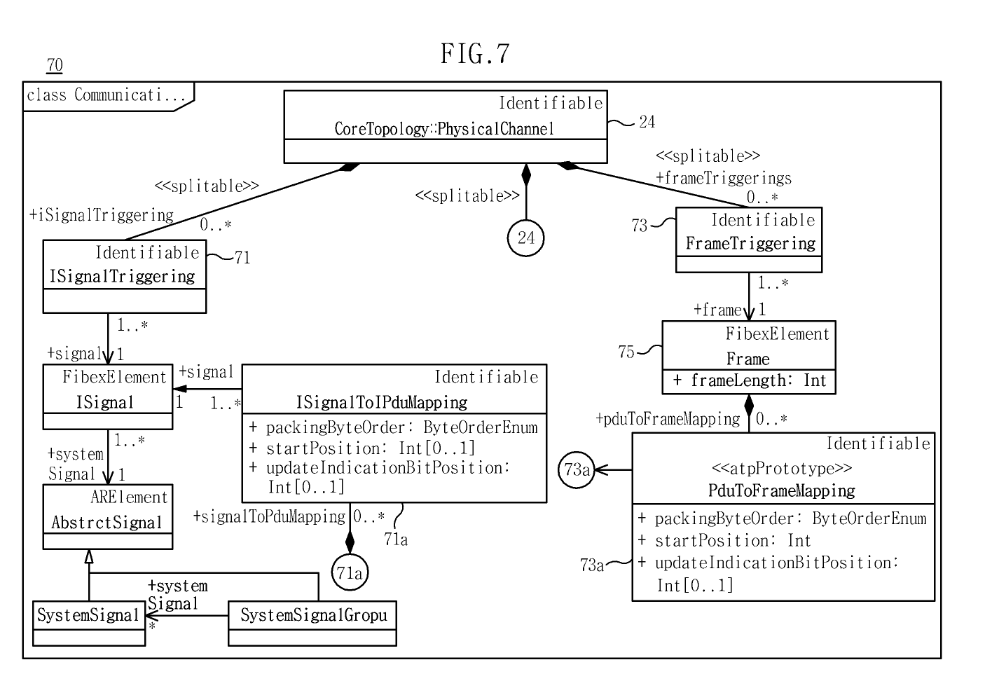

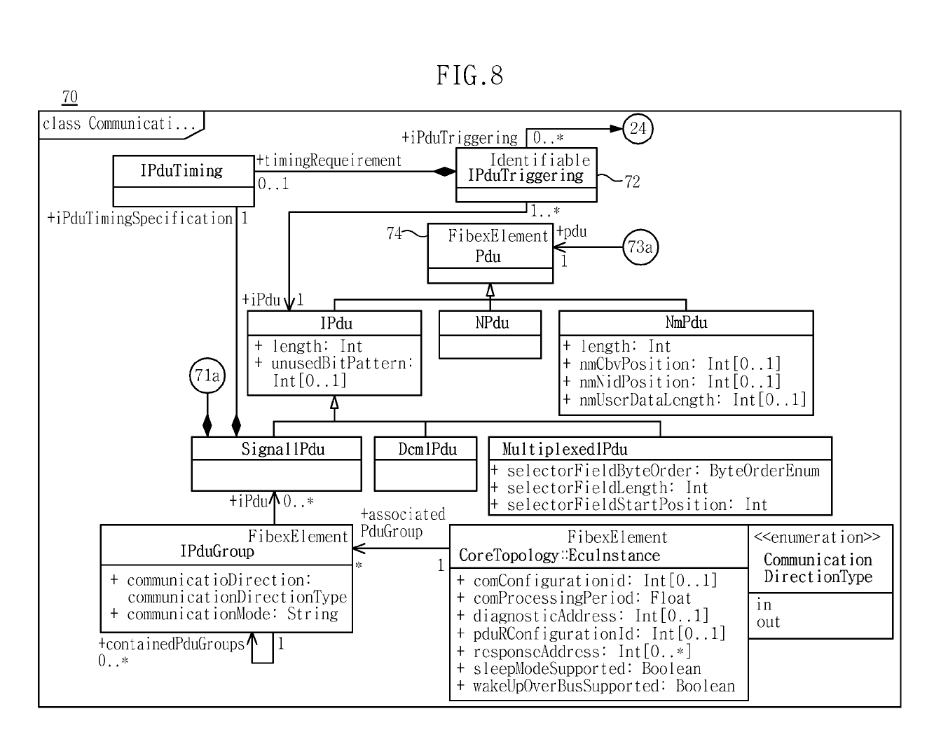

The communication data model based on AUTOSAR according to an embodiment of the present invention has the forms of FIGS. 7 to 10. In this regard, FIGS. 7 and 8 are diagrams showing a single communication data model 70.

Referring to FIGS. 7 to 10, the communication data model 70 includes a physical channel (PhysicalChannel) 24 generated during a procedure for setting up a network structure.

The physical channel 24 in the communication data model includes triggering instances corresponding to instances that are to be transmitted through the physical channel itself. Here, the triggering instances include an Interaction (I) signal triggering instance (ISignalTriggering) 71, an IPdu triggering instance (IPduTriggering) 72, and a frame triggering instance (FrameTriggering) 73.

The I signal triggering instance 71 includes only time information about signals.

The IPdu triggering instance 72 includes information about a channel through which a specific IPdu 74 is being transmitted.

The frame triggering instance 73 includes information about a frame to be transmitted through a specific channel.

The I signal triggering instance 71 and the IPdu triggering instance 72 are used when a specific ECU acts as a gateway. However, the frame triggering instance 73 is generally used for data transmission. In the embodiment of the present invention, a gateway setup step is excluded, but the present invention is not limited to this embodiment.

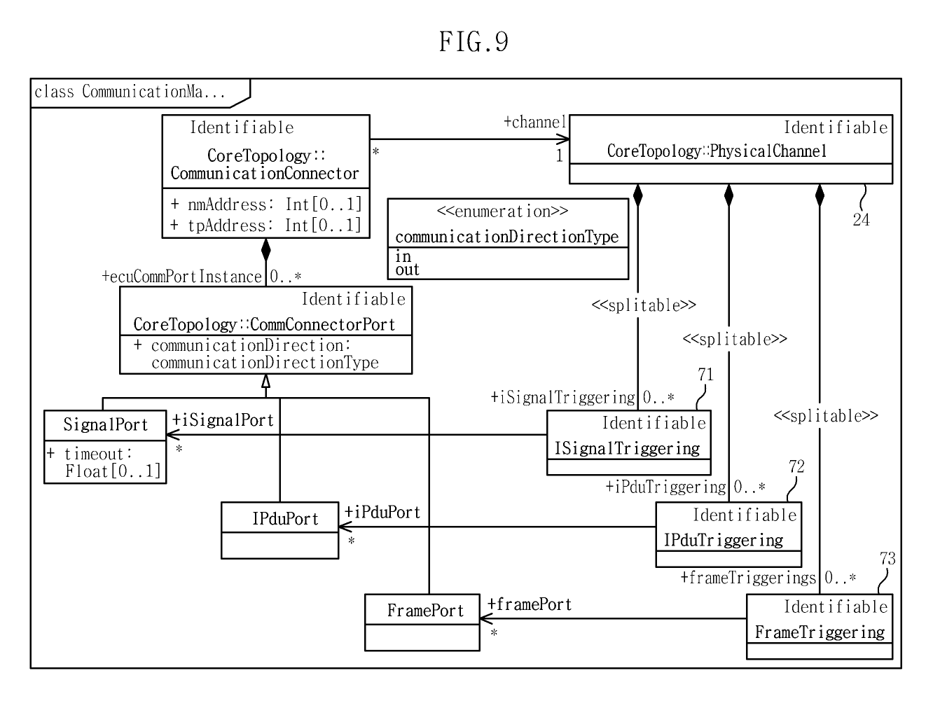

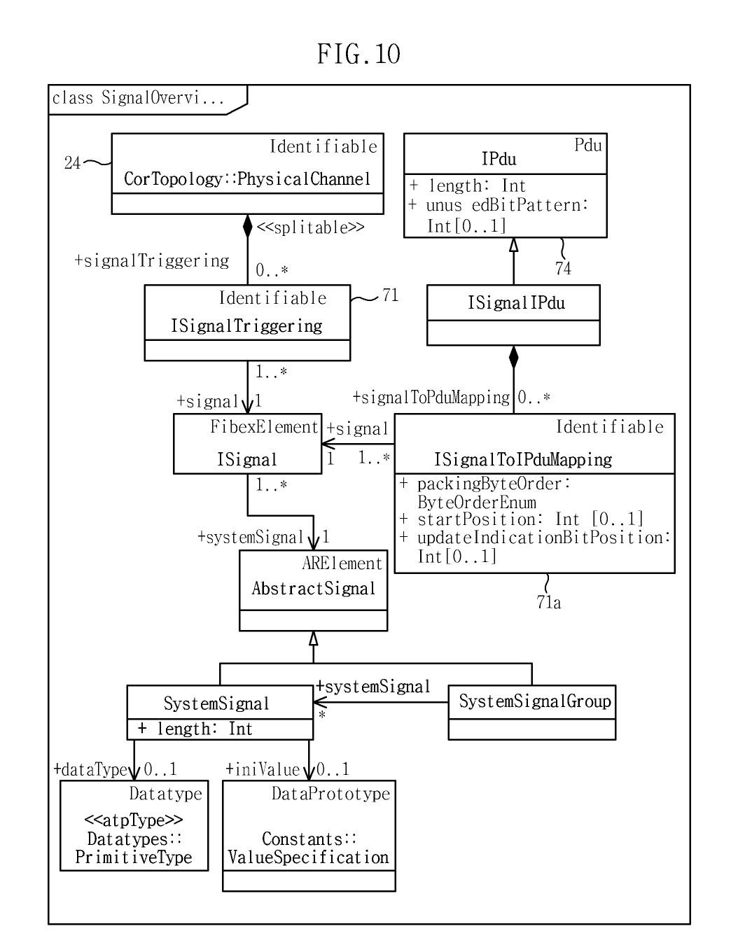

For example, data transmitted/received in the electronics application programs is represented by signals, as shown in FIG. 9. Referring to FIGS. 7 and 10, signals are transferred to the communication module of the ECU with the signals included in the IPdu 74. The IPdu 74 transferred in this way is finally generated in the form of frames for respective bus types, and the frames are then transmitted to the corresponding buses.

Referring to FIG. 10, system signals are referred to in the IPdu 74 via an Interaction (I) signal-to-Pdu mapping instance (ISignalToIPduMapping) 71a.

The IPdu 74 is referred to in a frame 75 via a Pdu-to-frame mapping instance (PduToFrameMapping) 73a.

Referring to FIG. 9, the frame 75 is referred to in the frame triggering instance 73. In such a frame 75, the final source and destination are determined with reference to ports possessed by the communication connector block 23 generated by the structure setup unit 100.

Since the above-described communication data model 70 based on AUTOSAR shown in FIGS. 7 to 10 is disclosed in detail in the Specification of the System Template V3.1.0 of AUTOSAR, a detailed description thereof will be omitted here.

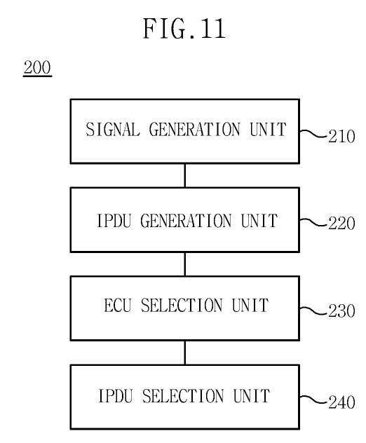

Next, the data setup unit 200 for setting up the structure of the communication data model 70 having the forms of FIGS. 7 to 10 will be described in detail with reference to FIG. 11.

FIG. 11 is a diagram showing the construction of the data setup unit according to an embodiment of the present invention.

Referring to FIG. 11, the data setup unit 200 includes a signal generation unit 210, an IPdu generation unit 220, an ECU selection unit 230, and an IPdu selection unit 240.

The signal generation unit 210 generates system signals (SystemSignal) and Interaction signals (ISignal) using a system signal wizard. In detail, the signal generation unit 210 sets up the names and detailed properties of the system signals and the I signals.

The IPdu generation unit 220 generates the IPdus 74 using an IPdu wizard. Further, the IPdu generation unit 220 generates an I signal-to-Pdu mapping instance 71a with reference to the I signals.

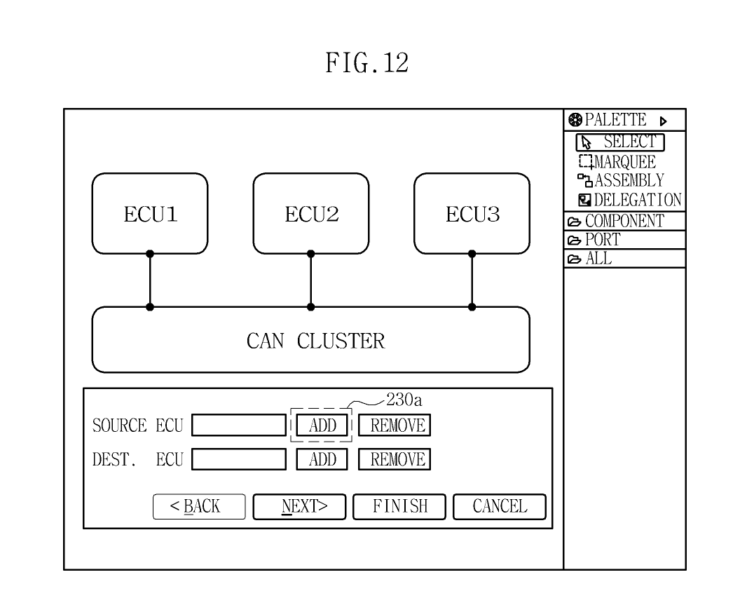

The ECU selection unit 230 selects ECU instances generated by the structure setup unit 100, for example, a source ECU instance functioning for transmission and a destination ECU instance functioning for reception, using a frame wizard (refer to 230a of FIG. 12). In this regard, the ECU selection unit 230 searches for communication connector blocks 23 included in the respective instances while selecting the source ECU instance and the destination ECU instance. In the case of the CAN bus, only one physical channel 24 is referred to by the communication connector blocks 23, and thus this physical channel 24 may be ignored. Further, in the case of a FlexRay bus, the ECU selection unit 230 may receive a channel to use, that is, a FlexRay physical channel 24a, and utilise the FlexRay physical channel 24a for searching for the communication connector blocks.

The IPdu selection unit 240 selects an IPdu 74 corresponding to the format of the frame for each bus type. Further, the IPdu selection unit 240 generates a frame triggering instance 73, which includes information about a frame to be transmitted through the physical channel 24, using the communication connector blocks 23. In this case, the IPdu selection unit 240 individually refers to a connector port block 25 having the transmission directionality of the communication connector block included in the source ECU instance, and a connector port block 25 having the reception directionality of the communication connector block included in the destination ECU instance.

The IPdu 74 selected by the IPdu selection unit 240 includes a Pdu-to-frame mapping instance 73a.

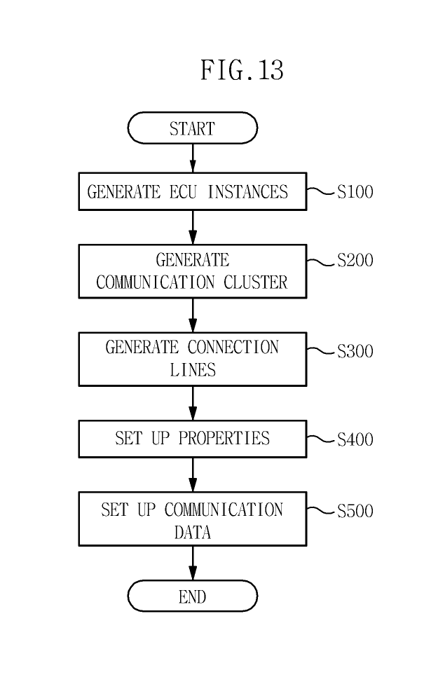

Next, a method of setting up a vehicle network based on AUTOSAR will be described in detail with reference to FIG. 13.

FIG. 13 is a flowchart showing a method of setting up a vehicle network based on AUTOSAR according to an embodiment of the present invention.

First, the vehicle network setup apparatus according to an embodiment of the present invention sets up a vehicle network based on AUTOSAR. Such a vehicle network setup apparatus includes a structure setup screen unit for receiving input values from a user and setting up a vehicle network.

Referring to FIG. 13, the AUTOSAR-based vehicle network setup apparatus allocates communication channels between ECUs corresponding to the components of vehicle network communication and then sets up a network structure based on the allocated communication channels between the ECUs.

In detail, the AUTOSAR-based vehicle network setup apparatus generates ECU instances 21 on the structure setup screen unit 110 at step S100. Here, each ECU instance 21 corresponds to a single instance included in each of the ECUs.

The AUTOSAR-based vehicle network setup apparatus generates a communication cluster block 26 corresponding to the type of communication bus on the structure setup screen unit 110 at step S200. That is, the communication cluster block 26 may be the FlexRay cluster 26a or the CAN cluster 26b according to the type of communication bus, for example, a FlexRay bus or a CAN bus. When the communication cluster block 26 is generated, the AUTOSAR-based vehicle network setup apparatus generates a physical channel 24 per communication cluster block 26.

The AUTOSAR-based vehicle network setup apparatus generates connection lines between the generated ECU instances 21 and the communication cluster block 26 at step S300. In this regard, the AUTOSAR-based vehicle network setup apparatus generates communication controller blocks 22 and communication connector blocks 23 for the respective ECU instances 21, and also generates reference blocks corresponding to the generated blocks. The AUTOSAR-based vehicle network setup apparatus also generates the reception and transmission ports of each communication connector block 23.

The AUTOSAR-based vehicle network setup apparatus sets up the detailed properties of the generated instances using a separate properties viewer at step S400.

Next, the AUTOSAR-based vehicle network setup apparatus sets up a network structure, and also sets up communication data that is transmitted through the communication channels between the ECUs by using a specific wizard at step S500. Here, the wizard corresponds to software for easily and conveniently executing complicated software or hardware operations using an interrogatory method, and includes a system signal wizard, an IPdu wizard, a frame wizard, etc.

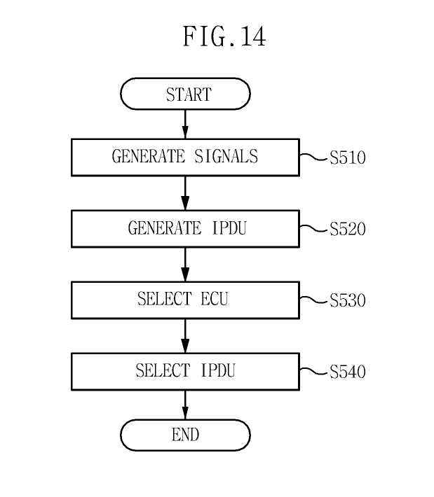

Next, a method of setting up the structure of the communication data model 70 in the method of setting up the vehicle network based on AUTOSAR will be described in detail with reference to FIG. 14.

Referring to FIG. 14, the AUTOSAR-based vehicle network setup apparatus generates system signals and I signals using the system signal wizard at step S510. In this case, the AUTOSAR-based vehicle network setup apparatus sets up the names and detailed properties of the system signals and the I signals.

The AUTOSAR-based vehicle network setup apparatus generates IPdus 74 using the IPdu wizard at step S520. In this case, the AUTOSAR-based vehicle network setup apparatus generates an I signal-to-Pdu mapping instance 71a with reference to the I signals.

The AUTOSAR-based vehicle network setup apparatus selects a source ECU instance and a destination ECU instance from among the ECU instances, generated at step S100, using the frame wizard at step S530. In this case, the AUTOSAR-based vehicle network setup apparatus searches for communication connector blocks 23 included in the respective instances while selecting the source ECU instance and the destination ECU instance.

The AUTOSAR-based vehicle network setup apparatus selects an IPdu 74 corresponding to the type of communication bus between the selected source ECU instance and the selected destination ECU instance at step S540. Further, the AUTOSAR-based vehicle network setup apparatus generates a frame triggering instance 73 including information about frames to be transmitted through the physical channel 24 using the communication connector blocks 23. In this case, the AUTOSAR-based vehicle network setup apparatus individually refers to a connector port block 25 having the transmission directionality of the communication connector block included in the source ECU instance, and a connector port block 25 having the reception directionality of the communication connector block included in the destination ECU instance.

As described above, the method of setting up a vehicle network based on AUTOSAR according to the embodiment of the present invention allows an electronics application developer to more easily set up a vehicle network model even if the configuration of a complicated network architecture model based on AUTOSAR is not known.

As described above, optimal embodiments of the present invention have been disclosed in the drawings and the present specification. In this case, although specific terms have been used, those terms are merely intended to describe the present invention and are not intended to limit the meanings and the scope of the present invention as disclosed in the accompanying claims. Therefore, those skilled in the art will appreciate that various modifications and other equivalent embodiments are also possible given the above description. Therefore, the technical scope of the present invention should be defined by the technical spirit of the accompanying claims.

What is claimed is:

1. An apparatus for setting up a vehicle network based on AUTomotive Open System ARchitecture (AUTOSAR), comprising:
a screen unit for receiving structure setup input values;
a structure setup unit for, when a user selects an Electronic Control Unit (ECU) and a communication cluster on the screen unit, displaying a communication channel between the ECU and the communication cluster, and setting up a network structure based on the communication channel; and
a data setup unit for setting up data that is transmitted through the communication channel using a wizard which is software for executing software or hardware operations using an interrogatory method.

2. The apparatus of claim 1, wherein the structure setup unit comprises:
an ECU instance generation unit for generating ECU instances, each operating in conjunction with a communication controller block and a communication connector block for each ECU, on the screen unit;
a cluster instance generation unit for generating communication clusters corresponding to types of communication buses on the screen unit;
a connection line generation unit for generating connection lines for connecting the ECU instances to the communication clusters; and
a property setup unit for setting up properties of the generated instances using a specific properties viewer.

3. The apparatus of claim 2, wherein the cluster instance generation unit generates a FlexRay cluster when the communication bus is a FlexRay bus, and generates a Controller Area Network (CAN) cluster when the communication bus is a CAN bus.

4. The apparatus of claim 3, wherein the cluster instance generation unit generates a relevant physical channel whenever each communication cluster is generated.

5. The apparatus of claim 2, wherein the connection line generation unit generates a communication controller block and a communication connector block between each ECU instance and each communication cluster and generates reference blocks corresponding to the communication controller block.

6. The apparatus of claim 1, wherein the structure setup unit sets up the network structure using a graphical user interface.

7. The apparatus of claim 1, wherein the wizard comprises a system signal wizard, an Interaction layer Protocol data unit (IPdu) wizard, and a frame wizard.

8. The apparatus of claim 7, wherein the data setup unit comprises:
a signal generation unit for generating system signals and Interaction (I) signals using the system signal wizard;
an IPdu generation unit for generating IPdus using the IPdu wizard;
an ECU selection unit for selecting a source ECU instance and a destination ECU instance from among the ECU instances using the frame wizard; and
an IPdu selection unit for selecting an IPdu corresponding to a frame for a type of a communication bus between the source ECU instance and the destination ECU instance.

9. The apparatus of claim 8, wherein the IPdu further comprises a Pdu-to-frame mapping instance.

10. The apparatus of claim 8, wherein the IPdu selection unit generates a frame triggering instance, which includes information about frames to be transmitted through a physical channel, using a communication connector block generated by the structure setup unit.

11. A method of setting up a vehicle network based on AUTomotive Open System ARchitecture (AUTOSAR), comprising:
receiving structure setup input values;
when a user selects an Electronic Control Unit (ECU) and a communication cluster, displaying a communication channel between the ECU and the communication cluster, and setting up a network structure based on the communication channel; and
setting up data that is transmitted through the communication channel using a wizard which is software for executing software or hardware operations using an interrogatory method.

12. The method of claim 11, wherein the setting up the network structure comprises:
generating ECU instances, each operating in conjunction with a communication controller block and a communication connector block for each ECU;
generating communication clusters corresponding to types of communication buses; and
generating connection lines for connecting the ECU instances to the communication clusters.

13. The method of claim 12, wherein the generating the communication clusters comprises:
generating a FlexRay cluster when the communication bus is a FlexRay bus; and
generating a Controller Area Network (CAN) cluster when the communication bus is a CAN bus.

14. The method of claim 13, wherein the generating the communication clusters is configured to generate a relevant physical channel whenever each communication cluster is generated.

15. The method of claim 12, wherein the generating the connection lines comprises:
generating a communication controller block and a communication connector block between each ECU instance and each communication cluster; and
generating reference blocks corresponding to the communication controller block.

16. The method of claim 11, wherein the setting up the network structure is configured to set up the network structure using a graphical user interface.

17. The method of claim 11, wherein the wizard comprises a system signal wizard, an Interaction layer Protocol data unit (IPdu) wizard, and a frame wizard.

18. The method of claim 17, wherein the setting up the data using the wizard comprises:
generating system signals and Interaction (I) signals using the system signal wizard;
generating IPdus using the IPdu wizard;
selecting a source ECU instance and a destination ECU instance from among the ECU instances using the frame wizard; and
selecting an IPdu corresponding to a frame for a type of a communication bus between the source ECU instance and the destination ECU instance.
